(19) United States
(12) Patent Application Publication
(10) Pub. No.: US 2024/0238146 A1
(43) Pub. Date: Jul. 18, 2024

(54) Invalid Stair-Climbing Assist Device

(71) Applicant: Timothy Rooney, Monticello, MN (US)

(72) Inventor: Timothy Rooney, Monticello, MN (US)

(21) Appl. No.: 18/359,988

(22) Filed: Jul. 27, 2023

Related U.S. Application Data
(60) Provisional application No. 63/438,590, filed on Jan. 12, 2023.

(51) Int. Cl. A61H 3/00; A61H 1/02

(52) U.S. Cl. CPC A61H 3/00; A61H 1/0237; A61H 2003/001; A61H 2003/007; A61H 2201/1276; A61H 2201/1635; A61H 2201/1642; A61H 2201/169

(57) ABSTRACT

The present invention relates to an invalid stair-climbing assist device. The device allows a user with one injured leg, foot, ankle, etc. to easily walk-up stairs. The device is comprised of a body that a user can rest their knee/lower leg upon, and a handle attached to the body that can be used for stability. During use, a user can lift the device from stair to stair while their injured leg rests on the device.

### CROSS-REFERENCE TO RELATED APPLICATION

The present application claims priority to, and the benefit of, U.S. Provisional Application No. 63/438,590, which was filed on Jan. 12, 2023, and is incorporated herein by reference in its entirety.

### FIELD OF THE INVENTION

The present invention relates generally to the field of stair-climbing devices. More specifically, the present invention relates to an invalid stair-climbing assist device that allows a user with one injured leg to easily walk-up stairs. The device is comprised of a body that a user can rest their knee/lower leg upon, and a handle attached to the body that can be used for stability and to lift the device from stair to stair. Accordingly, the present disclosure makes specific reference thereto. Nonetheless, it is to be appreciated that aspects of the present invention are also equally applicable to other like applications, devices, and methods of manufacture.

### BACKGROUND

Individuals with an injured foot, ankle, lower leg, or disability may have trouble traveling up and down the stairs. In many cases, no amount of weight can be put on the lower extremity to prevent further injury and promote healing. As a result, said individuals may need assistance moving up and down the stairs which can be frustrating and embarrassing, and wherein said assistance may not always be available.

Therefore, there exists a long-felt need in the art for a stair-climbing device. There also exists a long-felt need in the art for an invalid stair-climbing assist device. More specifically, there exists a long-felt need in the art for an invalid stair-climbing assist device that allows an invalid user with one injured leg, ankle, or foot to easily climb stairs. In addition, there exists a long-felt need in the art for an invalid stair-climbing assist device that allows an invalid user with one injured leg, ankle, or foot to easily climb stairs without the assistance of another individual.

The subject matter disclosed and claimed herein, in one embodiment thereof, comprises an invalid stair-climbing assist device. The device is primarily comprised of a body and a handle attached to the body. During use, a user can bend their injured leg and place their knee/lower leg on a top surface of the body after placing the body on a first step. Then, a user can use the handle to lift the body up to a second step. Then, a user can move their non-injured leg to the second step.

In this manner, the invalid stair-climbing assist device of the present invention accomplishes all the foregoing objectives and provides a stair-climbing device. During use, the device allows an invalid user with one injured leg, ankle, or foot to easily climb stairs while continuously supporting the injured leg. In addition, the device allows an invalid user with one injured leg, ankle, or foot to easily climb stairs without the assistance of another individual.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an invalid stair-climbing assist device primarily comprised of a body with at least one handle attached to the body. The body is preferably square in shape with a flat bottom surface. The flat bottom surface allows the device to remain stable when contacting the top surface of stairs during use of the device.

In one embodiment, the body is comprised of a foam material that cushions the knee/lower leg of a user when a user places said knee/lower leg on the top surface while using the device. In a different embodiment, the body is made from a plastic material with a top surface comprised of a padding for knee/lower leg comfort. In one embodiment, the top surface (and/or the padding) is comprised of a recessed area that receives the knee and/or lower leg of the user during use to keep the user's knee stable on the top surface while using the device.

The device is also comprised of at least one handle that preferably vertically extends upward from the body (i.e., away from the top surface). The handle may be any ergonomic shape known in the art. In one embodiment, the handle is comprised of at least one opening, such that the user can place their hand around/through the handle. In one embodiment, the handle is comprised of at least one grip preferably made from a non-slip material such as, but not limited to, rubber.

The present invention is also comprised of a method of using the device. First, a device is provided comprised of a body which is comprised of at least one handle attached to the body. Then, the bottom surface of the body is placed on a top surface of a first stair. Next, a user can place their knee and/or lower leg that is injured on the top surface after bending their knee/leg. Next, a user can place their non-injured leg on the stair. Then, the user can lift up the device via the handle while also lifting their injured leg supported on the top surface and place the body on the next (i.e., second) stair. Then, the user can bring their non-injured leg to said step and repeat the process as described to walk up a flight of stairs while supported by the device.

Accordingly, the invalid stair-climbing assist device of the present invention is particularly advantageous as it provides a device that allows an invalid user with one injured leg, ankle, or foot to easily climb stairs while continuously supporting the injured leg. In addition, the device allows an invalid user with one injured leg, ankle, or foot to easily climb stairs without the assistance of another individual. In this manner, the invalid stair-climbing assist device overcomes the limitations of existing methods of climbing stairs with an injured leg, foot, or ankle known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an invalid stair-climbing assist device of the present invention in accordance with the disclosed architecture;

FIG. 2 illustrates a perspective view of one potential embodiment of an invalid stair-climbing assist device of the present invention on a stair in accordance with the disclosed architecture;

FIG. 3 illustrates a perspective view of one potential embodiment of an invalid stair-climbing assist device of the present invention while being used by a user on a stair in accordance with the disclosed architecture; and

FIG. 4 illustrates a flowchart of a method of using one potential embodiment of an invalid stair-climbing assist device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a stair-climbing device. There also exists a long-felt need in the art for an invalid stair-climbing assist device. More specifically, there exists a long-felt need in the art for an invalid stair-climbing assist device that allows an invalid user with one injured leg, ankle, or foot to easily climb stairs. In addition, there exists a long-felt need in the art for an invalid stair-climbing assist device that allows an invalid user with one injured leg, ankle, or foot to easily climb stairs without the assistance of another individual.

The present invention, in one exemplary embodiment, is comprised of an invalid stair-climbing assist device. The device is primarily comprised of a body with at least one handle attached to the body. The body is preferably square in shape with a flat bottom surface that allows the device to remain stable when contacting the top surface of stairs during use of the device.

In one embodiment, the body is comprised of a foam material. The material cushions the knee/lower leg of a user when a user places said knee/lower leg on the top surface while using the device. In a different embodiment, the body is made from a plastic material with a top surface comprised of a padding for knee/lower leg comfort. In one embodiment, the top surface (and/or the padding) is comprised of a recessed area that receives the knee and/or lower leg of the user during use to keep the user's knee stable on the top surface while using the device.

The device is also comprised of at least one handle. The handle preferably vertically extends upward from the body (i.e., away from the top surface) and may be any ergonomic shape known in the art. In one embodiment, the handle is comprised of at least one opening, such that the user can place their hand around/through the handle. In one embodiment, the handle is comprised of at least one grip preferably made from a non-slip material such as, but not limited to, rubber.

The present invention is also comprised of a method of using the device. First, a device is provided comprised of a body which is comprised of at least one handle attached to the body. Then, the bottom surface of the body is placed on a top surface of a first stair. Next, a user can place their knee and/or lower leg that is injured on the top surface after bending their knee/leg. Next, a user can place their non-injured leg on the stair. Then, the user can lift up the device via the handle while also lifting their injured leg supported on the top surface and place the body on the next (i.e., second) stair. Then, the user can bring their non-injured leg to said step and repeat the process as described to walk up a flight of stairs while supported by the device.

Accordingly, the invalid stair-climbing assist device of the present invention is particularly advantageous as it provides a device that allows an invalid user with one injured leg, ankle, or foot to easily climb stairs while continuously supporting the injured leg. In addition, the device allows an invalid user with one injured leg, ankle, or foot to easily climb stairs without the assistance of another individual. In this manner, the invalid stair-climbing assist device overcomes the limitations of existing methods of climbing stairs with an injured leg, foot, or ankle known in the art.

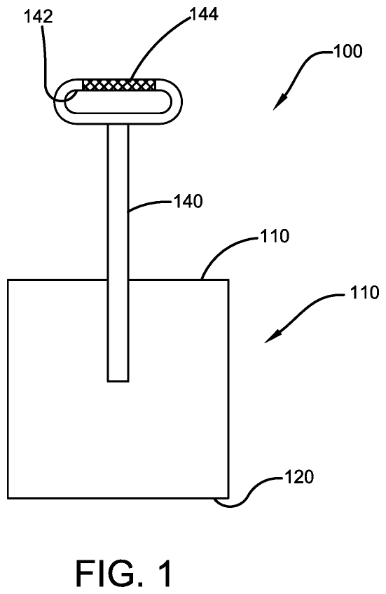

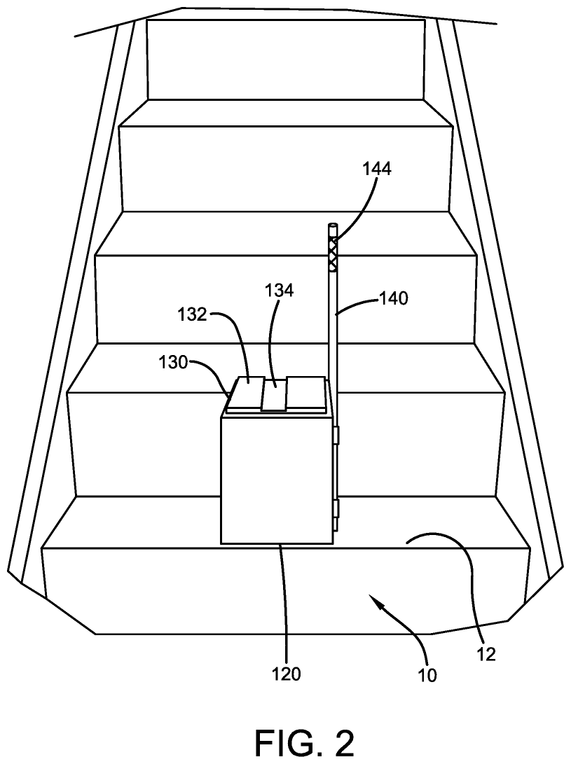

Referring initially to the drawings, FIG. 1 illustrates a side view of one potential embodiment of an invalid stair-climbing assist device 100 of the present invention in accordance with the disclosed architecture. The device 100 is primarily comprised of a body 110 with at least one handle 140 attached to the body 110. The body 110 is preferably square in shape. However, in different embodiments the body 110 may be any shape or configuration. Said configuration preferably has a flat bottom surface 120. The flat bottom surface 120 allows the device 100 to remain stable when contacting the top surface 12 of stairs 10 during use of the device 100, as seen in FIG. 2.

In one embodiment, the body 110 is comprised of a foam material of any type known in the art. Said material cushions the knee/lower leg of a user when a user places said knee/lower leg on the top surface 130 while using the device 100. In a different embodiment, the body 110 is made from a plastic material with a top surface 130 comprised of a padding 132 for knee/lower leg comfort. The padding 132 may be foam or any type of padding known in the art.

In one embodiment, the top surface 130 (and/or the padding 132) is comprised of a recessed area 134. The recessed area 134 receives the knee and/or lower leg of the user during use. Said area 134 keeps the user's knee stable on the top surface 130 (and/or padding 132) while using the device 100. In one embodiment, the top surface 130 may have the recessed area 134 and padding 132 over top of the recessed area 134.

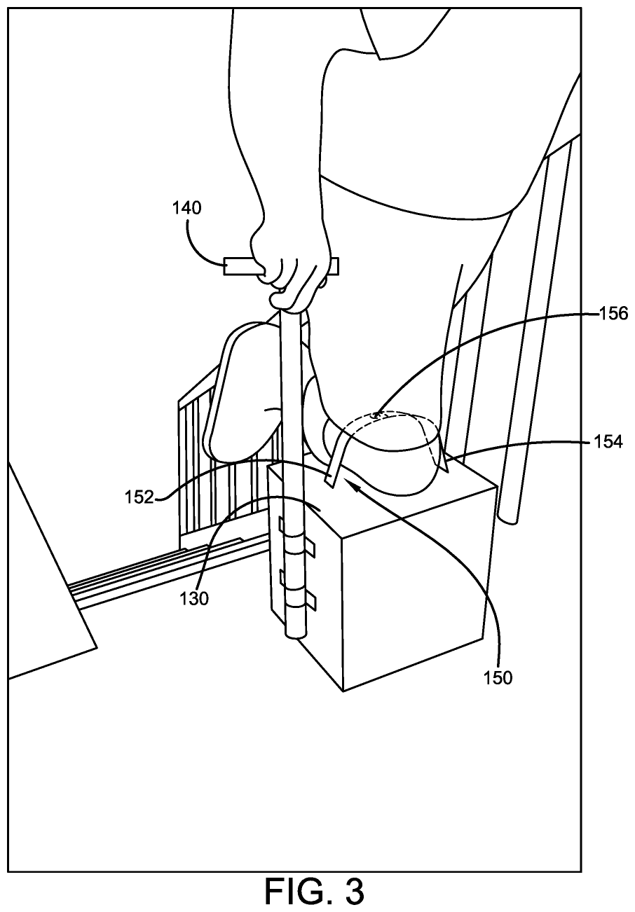

In one embodiment, the top surface 130 may be comprised of at least one strap assembly 150, as seen in FIG. 3. The assembly 150 may be comprised of a first strap 152 and a second strap 154 made from a fabric and/or elastic material (to accommodate a wide range of user sizes). Each strap 152,154 is comprised of at least one reciprocating fastener 156 such as, but not limited to, hook and loop, magnet, snap button, etc. In this manner, a user can fasten the straps 152,154 together to secure their lower leg to the top surface 130 during use for stabilizing.

The device 100 is also comprised of at least one handle 140. The handle 140 preferably vertically extends upward from the body 110 (i.e., away from the top surface 130). The handle 140 may be any ergonomic shape known in the art. In one embodiment, the handle 140 is comprised of at least one opening 142 such that the user can place their hand around/through the handle 140. In one embodiment, the handle 140 is generally T-shaped.

In one embodiment, the handle 140 is comprised of at least one grip 144. The grip 144 is preferably made from a non-slip material such as, but not limited to, rubber. The grip 144 may have a raised or recessed texture to promote further grip. The handle 140 may be fixedly or removably attached to the body 110 (i.e., via fasteners) in different embodiments. The handle 140 may be positioned on any position on the body 110 that allows a user to grab the handle 140 during use.

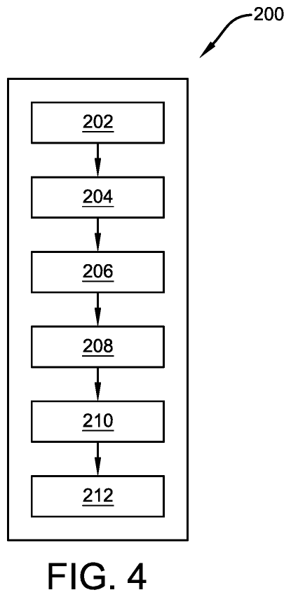

The present invention is also comprised of a method of using 200 the device 100, as seen in FIG. 4. First, a device 100 is provided comprised of a body 110 comprised of at least one handle 140 attached to the body [Step 202]. Then, the bottom surface 120 of the body 110 is placed on a top surface 12 of a first stair 10 [Step 204]. Next, a user can place their knee and/or lower leg that is injured on the top surface 130 after bending their knee/leg (as shown in FIG. 3) [Step 206]. Next, a user can place their non-injured leg on the stair 10 [Step 208]. Then, the user can lift up the device 100 via the handle 140 while also lifting their injured leg supported on the top surface 130 and place the body 110 on the next (i.e., second) stair 10 [Step 210]. Then, the user can bring their non-injured leg to said step and repeat the process as described to walk up a flight of stairs 10 while supported by the device 100 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “invalid stair-climbing assist device” and “device” are interchangeable and refer to the invalid stair-climbing assist device 100 of the present invention.

Notwithstanding the foregoing, the invalid stair-climbing assist device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the invalid stair-climbing assist device 100 as shown in the FIGS. are for illustrative purposes only, and that many other sizes and shapes of the invalid stair-climbing assist device 100 are well within the scope of the present disclosure. Although the dimensions of the invalid stair-climbing assist device 100 are important design parameters for user convenience, the invalid stair-climbing assist device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An invalid stair-climbing assist device comprising:
a body comprised of a foam material and a flat bottom surface; and
a vertical handle attached to the body.

2. The invalid stair-climbing assist device of claim 1, wherein the body is comprised of a foam material.

3. The invalid stair-climbing assist device of claim 1, wherein the vertical handle is comprised of a T-shaped handle.

4. The invalid stair-climbing assist device of claim 1, wherein the vertical handle is comprised of a grip.

5. The invalid stair-climbing assist device of claim 4, wherein the grip is comprised of a non-slip material.

6. The invalid stair-climbing assist device of claim 4, wherein the grip is comprised of a texture.

7. An invalid stair-climbing assist device comprising:
a body comprised of a flat bottom surface and a top surface; and
a vertical handle attached to the body.

8. The invalid stair-climbing assist device of claim 7 further comprised of a first strap and a second strap.

9. The invalid stair-climbing assist device of claim 8, wherein the first strap is comprised of a first fastener.

10. The invalid stair-climbing assist device of claim 8, wherein the second strap is comprised of a second fastener.

11. The invalid stair-climbing assist device of claim 8, wherein the first strap and the second strap are positioned on the top surface.

12. The invalid stair-climbing assist device of claim 8, wherein the top surface is comprised of a padding.

13. The invalid stair-climbing assist device of claim 8, wherein the top surface is comprised of a recessed area.

14. The invalid stair-climbing assist device of claim 8, wherein the handle is comprised of an opening.

15. The invalid stair-climbing assist device of claim 8, wherein the body is comprised of a plastic material.

16. A method of using an invalid stair-climbing assist device, the method comprising the steps of:
providing an invalid stair-climbing assist device comprised of a body and a handle attached to the body;
placing a bottom surface of the body on a first top surface of a first stair;
placing a knee of a first leg on a body top surface of the body;
placing a second leg on the first top surface of the first stair;
lifting the invalid stair climbing assist device upwards and onto a second top surface of a second step via the handle; and
placing the second leg on the second top surface.

17. The method of claim 16, wherein the invalid stair-climbing assist device is comprised of a first strap and a second strap.

18. The method of claim 17 further comprised of a step of fastening the first strap to the second strap around the knee of a user once the knee has been placed on the body top surface.

19. The method of claim 16, wherein the handle is comprised of an opening.

20. The method of claim 19 further comprised of a step of placing a hand of a user through the opening.
